(19) United States
(12) Patent Application Publication
(10) Pub. No.: US 2004/0160875 A1
(43) Pub. Date: Aug. 19, 2004

(54) Recording method, program, storage medium, and information recording apparatus

(76) Inventor: Yoshiyuki Sasaki, Tokyo (JP)

Correspondence Address: DICKSTEIN SHAPIRO MORIN & OSHINSKY LLP, 2101 L STREET NW, WASHINGTON, DC, 20037-1526, US

(21) Appl. No.: 10/758,048

(22) Filed: Jan. 16, 2004

(30) Foreign Application Priority Data
Jan. 23, 2003 (JP) PAT. 2003-014202

(51) Int. Cl. G11B 7/00

(52) U.S. Cl. 369/53.15

(57) ABSTRACT

A recording method for realizing high quality recording while preventing a degradation of the recording performance is disclosed. After recording data in a recording area of an information recording medium, a determination is made as to whether a defect detection process should be performed on at least a portion of the recording area in which the data are recorded based on a predetermined determination criterion pertaining to recording attribute information of the data. By setting the determination criterion with due consideration to the potential degradation of the recording performance, determining whether the determination criterion is satisfied based on the recording attribute information of the data, and determining to perform the defect detection process when the determination criterion is satisfied, high quality recording can be realized while preventing the degradation of the recording performance.

### BACKGROUND OF THE INVENTION

1. Field of the Invention

The present invention relates generally to a recording method, a program, a storage medium, and an information recording apparatus. Particularly, the present invention relates to a recording method for recording information on an information recording medium, a program that is used in an information recording apparatus, a storage medium on which such program is recorded, and an information recording apparatus that records information on an information recording medium.

2. Description of the Related Art

With the development of its functions, the personal computer (referred to as ‘PC’ hereinafter) is becoming capable of handling AV (audio-visual) information such as music and images. Since the amount of data in AV information is very large, attention is being directed to large capacity optical disks such as a CD (compact disk) and a DVD (digital versatile disk) as a recording medium. In turn, the price of such optical disks is becoming lower and an optical disk apparatus as the information recording apparatus for recording information on an optical disk is becoming widespread.

As an example of a standard of an optical disk, there is the Mt. Rainier standard. A CD-RW (CD-rewritable) conforming to this standard is called a CD-MRW, and a DVD+RW (DVD+rewritable) conforming to this standard is called a DVD+MRW. One feature of the Mt. Rainier standard is that it includes a defect management function for managing defect information including information on a defect area and its replacement area. Accordingly, in recording data on an optical disk conforming to the Mt. Rainier standard, if an area on which data are recorded includes a defect area, the data of the defect area are automatically recorded in a corresponding replacement area.

Normally, the defect area of an optical disk is detected through a so-called verification process in which a predetermined data pattern (dummy data) is recorded in an area of a recording region during a formatting process (referred to as ‘formatting’ hereinafter) of the optical disk, after which the data recorded in the area are replayed (reproduced) to obtain an error rate.

Also, the Mt. Rainier standard implements background formatting. Background formatting refers to a formatting scheme in which recording and replaying are prioritized so that when a recording request or a replay request is received from an external source during formatting, the formatting is interrupted to perform the requested recording or replay process. The formatting is resumed after the recording or replay process is completed. In this way, the user may be able to record/replay data to/from an optical disk even when the formatting on the optical disk is incomplete.

In such case, data may already be recorded before the verification process is performed. Thus, according to the Mt. Rainier standard, when data are recorded in an area on which the verification process has not yet been performed, the verification process may be performed on this area after the data recording and a determination may be made as to whether the data can be properly replayed. While the verification process may improve the recording quality, it may also increase the processing time for processing the recording request from a user, thereby degrading the so-called recording performance. The Mt. Rainier standard does not require the verification process to be performed after data recording if the verification process is already performed on the area before the data recording.

However, even when an area in which data are recorded is determined to be a non-defect area in the verification process, if a margin with respect to a determination criterion for detecting the defect area is very slim, there may be cases in which the data cannot be properly replayed depending on recording conditions under which the data are recorded. Thus, for example, in the prior art, an optical disk apparatus implementing a verification process in which a determination criterion for determining a defect area is arranged to be more restrictive than the conventional criterion is proposed (e.g., Japanese Laid-Open Patent No.07-176142).

As examples of defects that may influence the recording quality, an inherent defect such as a scratch may be inherently formed on the optical disk, and an acquired defect such as a property change in the property (e.g., a special alloy) included in a recording layer may occur due to repeated rewriting of data. The optical disk apparatus of the above prior art document is capable of accurately detecting the inherent defect, but is unable to detect the acquired defect. Consequently, data recorded in an area on which frequent rewriting has been performed may not be properly replayed. That is, the recording quality may be degraded.

Also, the Mt. Rainier standard does not provide any regulations with respect to the determination criterion for determining the defect area in the verification process. Thus, presently, manufacturers of information recording apparatuses are individually setting their own determination criteria for determining a defect area. As a result, even when an area is not determined to be a defect area in a verification process performed by one information recording apparatus, the data recorded in this area may not necessarily be properly replayed in another information recording apparatus that uses a different determination criterion.

### SUMMARY OF THE INVENTION

The present invention has been conceived in response to the above problems of the related art, and its first object is to provide a recording method and an information recording apparatus for realizing high quality recording while preventing the degradation of the recording performance.

A second object of the present invention is to provide a program that is run on a control computer of an information recording apparatus and is capable of realizing high quality recording while preventing the degradation of the recording performance, and a storage medium on which such program is recorded.

Specifically, a recording method of the present invention for recording data in a recording area of an information recording medium, includes:

a first step of determining whether to perform a defect detection process on at least a portion of the recording area in which the data are recorded based on a predetermined determination criterion pertaining to recording attribute information of the data.

According to the present invention, after recording data in a recording area of an information recording medium, a determination is made as to whether a defect detection process should be performed on at least a portion of the recording area in which the data are recorded based on a predetermined determination criterion pertaining to recording attribute information of the data. It is noted that ‘recording attribute information’ may correspond to information including information pertaining to the data being recorded on the information recording medium and information pertaining to the recording area on which the data are recorded, for example. By setting the criterion so as to distinguish a recording area that is likely to be a defect area and determine to perform the defect detection process thereon (and not on a recording area less likely to be a defect area), for example, the recording quality can be improved while the recording performance may not be significantly degraded.

According to the present invention, the recording area may correspond to an area on which the defect detection process has never been performed, or alternatively, the recording area may include an area on which the defect detection process is already performed at least once.

In a further embodiment, the recording attribute information may include information on the data size of the data, and in such case, the determination criterion may correspond to a criterion for determining to perform the defect detection process when the data size of the data is less than or equal to a preset first threshold value.

In another embodiment, the recording attribute information may include division information pertaining to dividing the data into a plurality of data sections, and in such case, the determination criterion may correspond to a criterion of determining to perform the defect detection process when a data section of which a data size is less than or equal to a preset second threshold value exists among the data sections, the defect detection process being performed on at least a portion of the recording area in which the data section is recorded.

In another embodiment, the recording attribute information may include information pertaining to the recording area in which the data are recorded, and in such case, the determination criterion may correspond to a criterion of determining to perform the defect detection process when the recording area includes an area that is in a vicinity of a known defect area.

In another embodiment, the recording method of the present invention may further include:

a second step of performing the defect detection process when a determination is made in the first step to perform the defect detection process to determine whether a defect area is included in the processing area; and

a third step of recording defect area data in a predetermined replacement area when a defect area is detected in the second step.

It is noted that various processes may be implemented as the defect detection process, and in one embodiment, the defect detection process may correspond to a verification process.

Also, in one embodiment, the information recording medium may conform to the Mt. Rainier standard.

A program of the present invention is implemented in an information recording apparatus that is adapted to record information on an information recording medium, and the program is run on a control computer of the information recording apparatus to realize:

a first procedure of recording data in a recording area of the information recording medium in response to a request from an external source; and

a second procedure of determining after the recording of the data whether to perform a defect detection process on at least a portion of the recording area in which the data are recorded based on a predetermined determination criterion pertaining to recording attribute information of the data.

The program of the present invention is loaded into a main memory, and when a start address of the program is set to a program counter, the control computer of the information recording apparatus records data in a recording area of an information recording medium according to a request from an external source. After recording the data, a determination is made as to whether a defect determination process should be performed on at least a portion of the recording area in which the data are recorded based on a predetermined determination criterion pertaining to recording attribute information of the data. That is, according to the program of the present invention, the control computer of the information recording apparatus may be controlled to perform the recording method of the present invention. In this way, high quality recording may be realized while preventing the degradation of the recording performance.

According to a further embodiment, the program of the present invention may further include a third procedure of performing the defect detection process when a determination is made in the second procedure to perform the defect detection process, and if a defect area is detected, recording defect area data of the defect area in a predetermined replacement area.

A computer readable storage medium of the present invention may be used to store the program of the present invention.

By running the program stored in the storage medium of the present invention on a computer, high quality recording can be realized while preventing the degradation of the recording performance.

An information recording apparatus of the present invention that is adapted to record information on an information recording medium includes:

recording means for recording data on the information recording medium in response to a recording request from an external apparatus; and

determination means for determining after the recording of the data whether to perform a defect detection process on at least a portion of the recording area in which the data are recorded based on recording attribute information of the data.

According to the present invention, when a data recording request is received from an external apparatus, the data are recorded on the information recording medium by the recording means. Then, after the data recording, a determination is made by the determination means as to whether a defect detection process should be performed on at least a portion of the recording area in which the data are recorded based on recording attribute information of the data. Thus, for example, a determination to perform the defect detection process may be made by the determination means in a case where it is determined based on the recording attribute information of the data that performing the defect detection process would be effective. Accordingly, high quality recording may be realized while preventing the degradation of the recording performance.

In a further embodiment, the information recording apparatus may include replacement means for performing the defect detection process when a determination is made by the determination means to perform the defect detection process, and if a defect area is detected, recording defect area data of the defect area in a predetermined replacement area.

In another embodiment, the recording attribute information may include information on a data size of the data, and in such case, the determination means may determine to perform the defect detection process when the data size of the data is less than or equal to a preset first threshold value.

In a further embodiment, the information recording apparatus of the present invention may include a memory for temporarily storing the data, and in such case, the first threshold value may be set to a value corresponding to an amount of data that can be stored in the memory.

In another embodiment, the recording attribute information may include division information pertaining to dividing the data into a plurality of data sections, and in such case, the determination means may determine to perform the defect detection process when a data section of which a data size is less than or equal to a preset second threshold value exists among the data sections, the defect detection process being performed on at least a portion of the recording area in which the data section is recorded.

In a further embodiment, the information recording apparatus may include a memory for temporarily storing the data, and in such case, the second threshold value may be set to a value corresponding to an amount of data that can be stored in the memory.

In another embodiment, the recording attribute information may include information pertaining to the recording area in which the data are recorded, and in such case, the determination means may determine to perform the defect detection process when the recording area in which the data are recorded includes an area that is in a vicinity of a known defect area.

In another embodiment, the information recording apparatus of the present invention may further include a memory for temporarily storing the data, and in such case, the determination means may obtain information on a partial recording area in which data remaining in the memory are recorded based on the recording attribute information, and may determine to perform the defect detection process on the partial recording area.

It is noted that various processes may be implemented as the defect detection process of the present invention, and in one embodiment, the defect detection process may correspond to a verification process.

Also, the information recording medium on which data are recorded by the information recording apparatus of the present invention may conform to the Mt. Rainier standard.

### BRIEF DESCRIPTION OF THE DRAWINGS

FIG. 1 is a block diagram showing a configuration of an optical disk apparatus according to an embodiment of the present invention;

FIGS. 2A-2C are diagrams showing exemplary configurations of a recording region of a DVD+MRW;

FIG. 3 is a flowchart illustrating a recording operations process according to an embodiment of the present invention that is performed in response to the reception of a write command from a host during a formatting process;

FIG. 4 is a flowchart illustrating the recording operations process continued from FIG. 3 that is performed in response to the reception of a write command from the host during a formatting process;

FIG. 5 is a flowchart illustrating a recording operations process according to an embodiment of the present invention that is performed on a formatted optical disk in response to the reception of a write command from the host;

FIGS. 6A and 6B are diagrams illustrating a defect area and a semi-defect area that is in the vicinity of the defect area;

FIG. 7 is a flowchart illustrating a first variation of the recording operations process according to the present embodiment that is performed on a formatted optical disk upon receiving a write command from the host;

FIG. 8 is a diagram illustrating the recording operations process of FIG. 7;

FIG. 9 is a flowchart illustrating a second variation of the recording operations process according to the present embodiment that is performed on a formatted optical disk upon receiving a write command from the host;

FIG. 10 is a diagram illustrating the recording operations process of FIG. 9;

FIG. 11 is a flowchart illustrating a third variation of the recording operations process according to the present embodiment that is performed on a formatted optical disk upon receiving a write command from the host; and

FIG. 12 is a diagram illustrating the recording operations process of FIG. 11.

### DESCRIPTION OF THE PREFERRED EMBODIMENTS

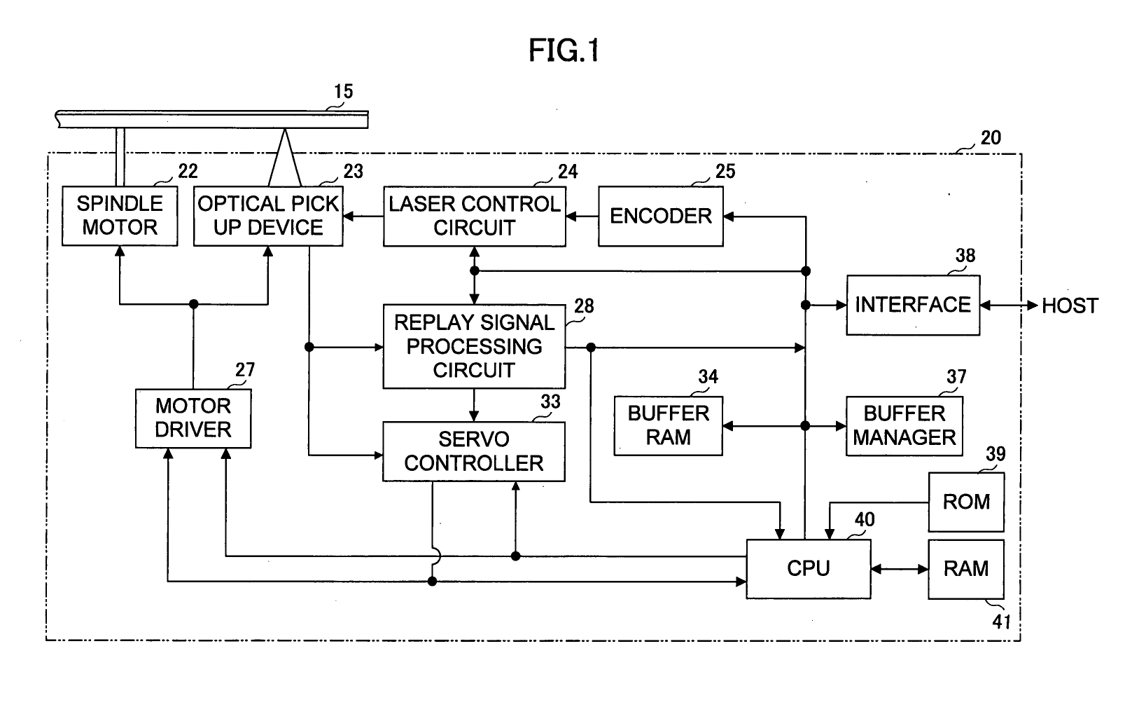

In the following, a preferred embodiment of the present invention is described with reference to FIGS. 1-5.

FIG. 1 is a block diagram illustrating an optical disk apparatus corresponding to an information recording apparatus according to an embodiment of the present invention.

The optical disk apparatus 20 of FIG. 1 may include, for example, a spindle motor 22 for rotating an optical disk 15 corresponding to an information recording medium, an optical pickup device 23, a laser control circuit 24, an encoder 25, a motor driver 27, a replay signal processing circuit 28, a servo controller 33, a buffer RAM 34 as a memory, a buffer manager 37, an interface 38, a ROM 39, a CPU 40, and a RAM 41. It is noted that the arrows shown in FIG. 1 illustrate a general flow of signals and information and do not represent the entire connecting relation between the blocks. Also, in the present example, it is assumed that an information recording medium conforming to the DVD+MRW standard is used as the optical disk 15.

The optical pickup device 23 may be a device for irradiating a laser beam onto a recording surface of the optical disk 15 on which surface a spiral track or concentric tracks (recording region) are formed, and receiving reflected light from the recording surface. The optical pickup device 23 may include a semiconductor laser as a light source, an optical system that guides a bundle of optical beams emitted from the semiconductor laser to the recording surface of the optical disk 15 and guides a bundle of optical beams reflected from the recording surface to a predetermined light receiving position, an optical receiver that is placed at the light receiving position for receiving the reflected bundle of optical beams, and a drive system (including a focusing actuator, a tracking actuator, and a seek motor, none of which are shown in the drawing), for example. The optical receiver may output a signal to the replay signal processing circuit 28 according to the amount of light it receives.

The replay signal processing circuit 28 may detect a wobble signal, an RF signal, and a servo signal (e.g., focus error signal and track error signal), for example, based on the output signal from the optical receiver. The replay signal processing circuit 28 may, for example, extract ADIP (address in pregroove) information and a synchronization signal from the detected wobble signal and output the ADIP information to the CPU 40 and the synchronization signal to the encoder 25. The replay signal processing circuit 28 may, for example, perform a decoding process and an error correction process on the detected RF signal and store the resulting signal as replay data in the buffer RAM 34 via the buffer manager 37. Herein, an error (error rate) occurring in the decoding process is signaled to the CPU 40. The replay signal processing circuit 28 may also output the detected signal to the servo controller 33, for example.

The servo controller 33 generates a control signal for correcting a focus deviation based on the focus error signal from the replay signal processing circuit 28, and generates a control signal for correcting a track deviation based on the track error signal from the replay signal processing circuit 28.

The motor driver 27 drives the tracking actuator and focusing actuator of the optical pickup device 23 based on the control signals from the servo controller 33. In other words, tracking control and focus control are performed by the replay signal processing circuit 28, the servo controller 33, and the motor driver 27. Also, the motor driver 27 drives the spindle motor 22 and the seek motor of the optical pickup device 23 based on instructions from the CPU 40.

The buffer manager 37 manages the input/output of data to the buffer RAM 34, and signals the CPU 40 when the amount of data accumulated in the buffer RAM 34 reaches a predetermined value.

The encoder 25 extracts data stored in the buffer RAM 34 via the buffer manager 37 according to an instruction from the CPU 40, performs processes such as data demodulation and attachment of error correction code, generates a write signal to be written on the optical disk 15, and outputs to the laser control circuit 24 the generated signal in sync with the synchronization signal from the replay signal processing circuit 28.

The laser control circuit 24 controls the output of the optical beam emitted from the optical pickup device 23 based on the write signal from the encoder 25 and an instruction from the CPU 40.

The interface 38 corresponds to a bidirectional communication interface with a host (e.g., PC), and may be a standard interface conforming to ATAPI (AT Attachment Packet Interface), SCSI (Small Computer System Interface), or USB (Universal Serial Bus), for example.

The ROM 39 stores programs including a program according to an embodiment of the present invention for recording data on the optical disk 15 according to a recording request from the host (referred to as ‘recording process program’ hereinafter), which program is described in code readable by the CPU 40 and is described in detail below.

The CPU 40 controls the operation of each of the component parts of the optical disk apparatus 20 according to the programs stored in the ROM 39, and temporarily stores in the RAM 41 data to be used for such control, for example. The RAM 41 includes a formatting information area for temporarily storing information pertaining to formatting (referred to as ‘formatting information’ hereinafter) a defect information area for temporarily storing defect information. When the power of the optical disk apparatus 20 is turned on, the programs stored in the ROM 39 are loaded in a main memory (not shown) of the CPU 40.

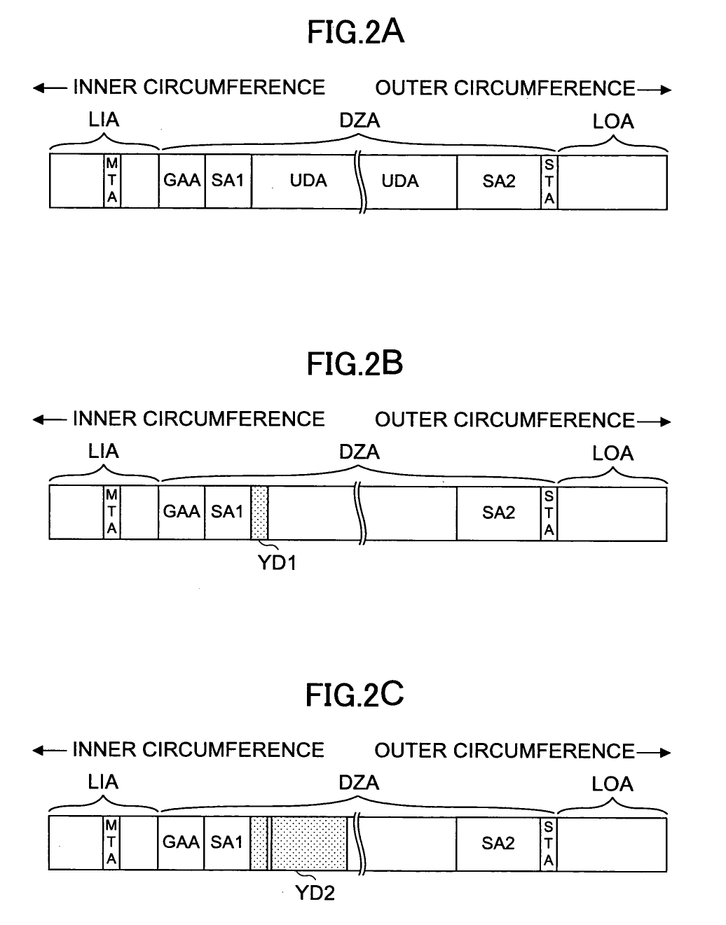

The recording region of the optical disk 15 conforming to the DVD+MRW standard may have a configuration as shown in FIG. 2A, for example. In FIG. 2A, the recording region is divided into three areas, namely, a lead-in area (LIA), a data zone area (DZA), and a lead-out area (LOA), that are laid out in this order from the inner circumference side to the outer circumference side. It is noted that the optical disk 15 may have a spiral track or concentric tracks; however, in FIGS. 2A-2C, for the sake of convenience, the track(s) of the optical disk 15 are indicated in a straight line wherein the left side represents the inner circumference side and the right side represents the outer circumference side.

The lead-in area (LIA) has an area called a main table area (MTA) in which formatting information and defect information, for example, are recorded.

The data zone area (DZA) has a user data area (UDA) in which user data are recorded, as well as a general application area (GAA), a space area 1 (SA1), a space area 2 (SA2), and a secondary table area (STA). The GAA is read by a designated driver when the optical disk 15 is set to a drive apparatus, and is used to identify the optical disk 15 as being in accordance with the Mt. Rainier standard. Information recording on the GAA is performed according to an instruction from the host. The SA1 and SA2 each correspond to replacement areas for the defect areas of the user data area (UDA). The STA corresponds to an area that stores contents identical to those stored in the MTA.

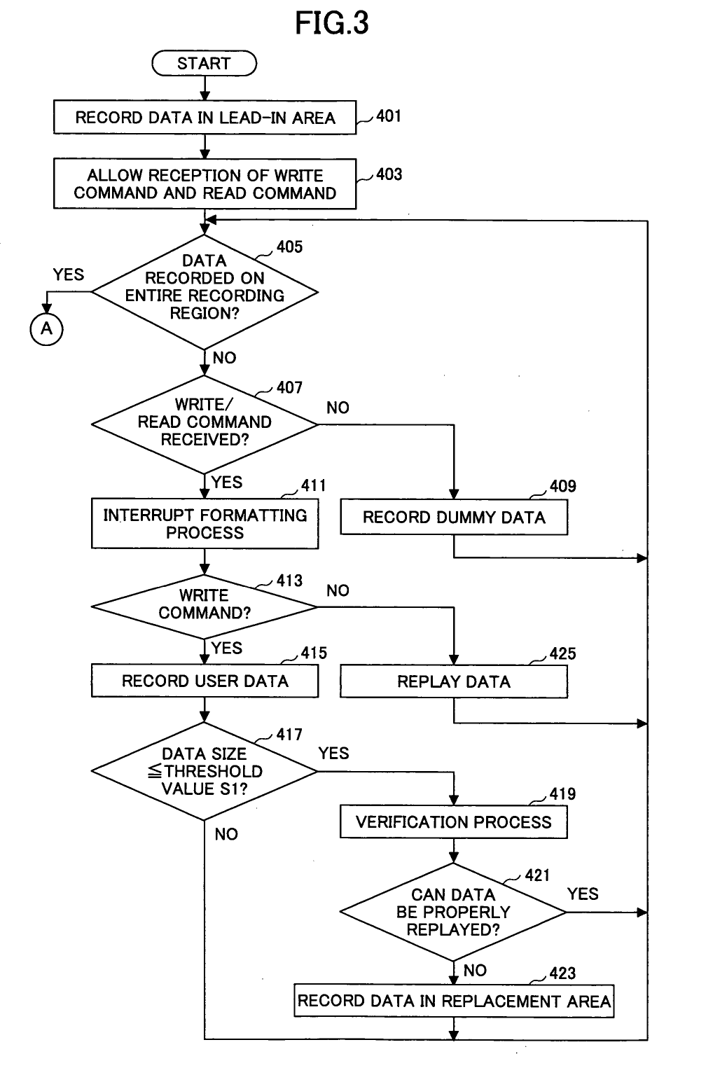

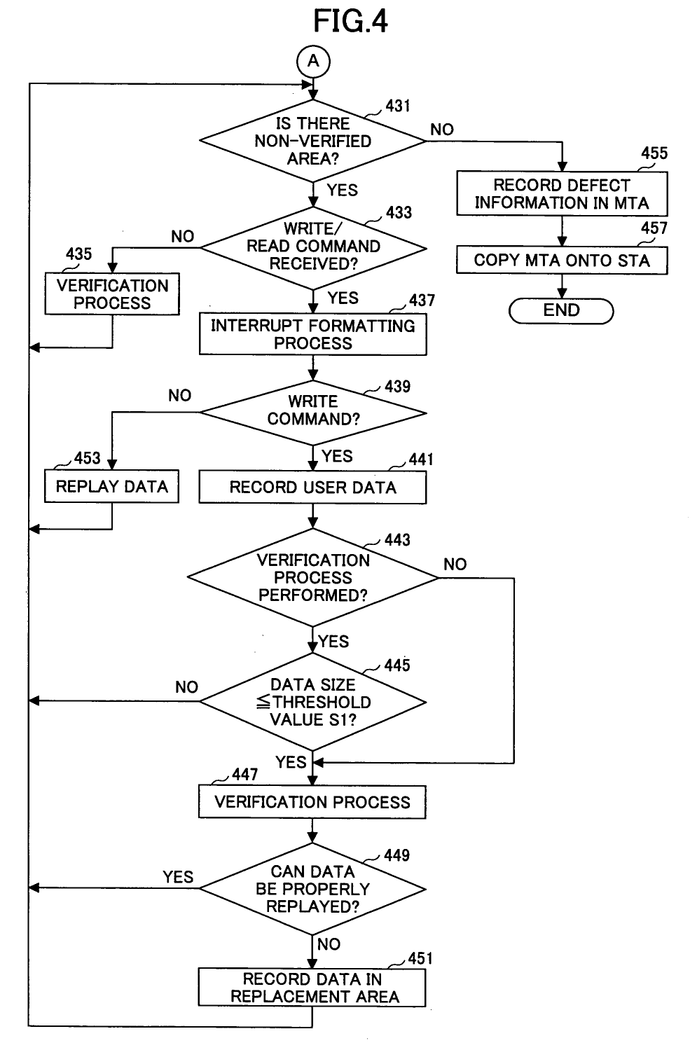

In the following, an operations process of the optical disk apparatus 20 is described using FIGS. 2B-FIG. 4. This process is performed upon receiving a formatting command requesting formatting of an optical disk according to the DVD+MRW standard (referred to as ‘formatting command’ hereinafter). FIGS. 3 and 4 are flowcharts illustrating process algorithms that are executed by the CPU 40.

When a formatting command to format a blank disk is received from the host, a start address of a program corresponding to the flowcharts of FIGS. 3 and 4 is set to a program counter of the CPU 40, and the present operations process is started. Herein, it is assumed that the optical disk 15 corresponds to a blank disk. Also, it is assumed that a discharge request and a formatting termination request are not issued during the process, and the user data can be maintained in the buffer RAM 34.

In step 401 of FIG. 3, predetermined information (e.g., MTA data) is recorded in the lead-in area (LIA).

Then, in step 403, the host is notified of the completion of the formatting process on the lead-in area (LIA) of step 401, and reception of a recording request and a replay request are allowed. Then, initialization takes place by setting a reception flag to ‘0’ (zero). The reception flag indicates whether a recording request or a replay request is received. It is noted that in the present embodiment, communications with the host, that is, transmission and reception of data to/from the host are realized by interruption processes. Thus, when a command requesting a replay (read command) or a command requesting a recording (write command) are received from the host, the reception flag is set to ‘1’.

Then, in step 405, a determination is made as to whether data (including dummy data) are recorded in the entire recording region of the optical disk 15. In this case, data are not recorded in the entire recording region of the optical disk 15 and, therefore, a negative determination is made in step 405. Then, the process moves on to step 407.

In step 407, a determination is made as to whether a write command or a read command from the host has been received by referring to the reception flag. If the reception flag is set to ‘0’, a negative determination is made in step 407, and the process moves on to step 409.

In step 409, for example, 16 sectors (=1 ECC block) of dummy data are recorded in an unrecorded portion of the recording region. The recording of dummy data is first performed on the data zone area, and then on the lead-out area (LOA) and on the remaining portion of the lead-in area (LIA). According to the Mt. Rainier standard, this operation is called ‘de-icing’. Information pertaining to the area in which the dummy data is recorded is stored in the formatting information area of the RAM 41. Then, the process goes back to step 405.

The formatting of the optical disk 15 proceeds through a repetition of the cycle of the process steps 405→407→409 until a positive determination is made in one of the process steps 405 and 407.

In step 407, if the reception flag is set to ‘1’, a positive determination is made and the reception flag is reset to ‘0’ after which the process moves on to step 411.

In step 411, the formatting is interrupted, and the progress of the recording of dummy data and the verification process are stored in the formatting information area of the RAM 41. The progress information may also be stored in predetermined areas of the MTA and the STA.

Then, in step 413, the received command is analyzed to determine whether the command from the host corresponds to a write command. If the command from the host corresponds to a write command, a positive determination is made, and the process moves on to step 415.

In step 415, the user data stored in the buffer RAM 34 are recorded in a designated area of the user data area (referred to as ‘designated area’ hereinafter). The details of this process step are described below. After the recording of the user data is completed, the process moves on to step 417.

In step 417, a determination is made as to whether the data size of the user data is less than or equal to a first predetermined threshold value S1. It is noted that a default value for the threshold value S1 is stored in the ROM 39; however, this value may be changed to an arbitrary value by the host, for example. FIG. 2B illustrates a case in which the user data are recorded in an area YD1. As in this example, when the data size of the recorded user data is less than or equal to the threshold value S1, a positive determination is made, in which case a verification process is determined to be executed, and the process moves on to step S419. It is noted that the threshold value S1 may be set to a value corresponding to the size of an area provided in the buffer RAM 34 for storing the user data (memory capacity).

In step 419, a verification process is performed. Specifically, user data in the designated area is replayed to obtain an error rate.

Then, in step 421, a determination is made as to whether the user data recorded in the designated area may be properly replayed based on the result of the verification process. For example, if the error rate is less than or equal to a predetermined value so that the user data may be properly replayed, a positive determination is made, and the process goes back to step 405. On the other hand, if the user data cannot be properly replayed, a negative determination is made, and the process moves on to step 423.

In step 423, user data are recorded in a predetermined replacement area, and defect information is stored in the defect information area of the RAM 41, after which the process goes back to step 405.

FIG. 2C illustrates an example in which user data are recorded in an area YD2. As in this example, when the data size of the recorded user data is greater than the threshold value S1, a negative determination is made in step 417, in which case the verification process is determined not to be executed, and the process goes back to step 405.

In step 413, if the command from the host corresponds to a read command, a negative determination is made, and the process moves on to step 425.

In step 425, data recorded in an area designated by the host are replayed and transmitted to the host. The details of this process step are described below. When the replaying of data is completed, the process goes back to step 405.

Then, when data (including dummy data) are recorded in the entire recording region, a positive determination is made in step 405, and the process moves on to step 431 of FIG.4.

In step 431, a determination is made as to whether there is an area on which the verification process has not yet been performed (referred to as ‘non-verified area’ hereinafter) within the recording region by referring to the formatting information area of the RAM 41. If a non-verified area exists within the recording region, a positive determination is made, and the process moves on to step 433.

In step 433, a determination is made as to whether a write command or a read command is received from the host as in step 407 of FIG. 3. If the reception flag is not set to ‘1’, a negative determination is made, and the process moves on to step 435.

In step 435, a verification process is performed on a non-verified area of 16 sectors, for example. Information pertaining to the area on which the verification process has been performed is stored in the formatting information area of the RAM 41. If it is determined based on the verification result that the area corresponds to a defect area, the defect information is stored in a defect information area of the RAM 41. Then, the process goes back to step 431.

On the other hand, if the reception flag is set to ‘1’, a positive determination is made in step 433, and the reception flag is reset to ‘0’, after which the process moves on to step 437.

In step 437, the formatting operation is interrupted as in step 411 of FIG. 3, and the process moves on to step 439.

In step 439, a determination is made as to whether the command from the host is a write command. If the command from the host corresponds to a write command, a positive determination is made, and the process moves on to step 441.

In step 441, the user data stored in the buffer RAM 34 are recorded in the designated area. After the recording of user data is completed, the process moves on to step 443.

In step 443, a determination is made as to whether the verification process is already performed on the designated area by referring to the formatting information area of the RAM 41. If the verification process is not yet performed, a negative determination is made, and the process moves on to step 447. On the other hand, if the verification process is already performed, a positive determination is made, and the process moves on to step 445.

In step 445, a determination is made as to whether the data size of the user data is less than or equal to the threshold value S1. If the data size is less than or equal to the threshold value S1, a positive determination is made, in which case the verification process is determined to be executed, and the process moves on to step 447.

In step 447, the verification process is performed.

Then, in step 449, a determination is made as to whether the user data recorded in the designated area can be properly replayed based on the result of the verification process. If the user data can be properly replayed, a positive determination is made in this step, and the process goes back to step 431. On the other hand, if the user data cannot be properly replayed, a negative determination is made in this step, and the process moves on to step 451.

In step 451, the user data are recorded in a predetermined replacement area, and the defect information is stored in the defect information area of the RAM 41, after which the process goes back to step 431.

In step 445, if the data size is greater than the threshold value S1, a negative determination is made, namely, the verification process is determined not to be executed, and the process goes back to step 431.

Also, in step 439, if the command from the host corresponds to a read command, a negative determination is made, and the process moves on to step 453.

In step 453, data recorded in an area designated by the host are replayed and transmitted to the host. After the replaying of data is completed, the process goes back to step 431.

In step 431, if a non-verified area does not exist, a negative determination is made, and the process moves on to step 455.

In step 455, defect information and formatting information stored in the RAM 41 are recorded in the MTA.

Then, in step 457, the contents of the MTA are copied onto the STA, and the operations process executed in response to receiving the formatting command is ended, that is, the formatting of the optical disk 15 is completed.

In the following, a detailed description of the user data recording process performed in steps 415 and 441 is given.

First, a control signal for controlling the rotation of the spindle motor 22 according to the recording speed is output to the motor driver 27, and the buffer manager 37 is instructed to accumulate user data received from the host in the buffer RAM 34. Also, the reception of the write command from the host is signaled to the replay signal processing circuit 28. In this way, the tracking control and focus control can be performed when the rotation speed of the optical disk 15 reaches a predetermined linear speed. The tracking control and the focus control may be performed as necessary or desired throughout the recording process.

Then, referring to the defect information, if the designated area includes a defect area, a corresponding replacement area is arranged to be the write area, and based on the ADIP (address in pregroove) information output from the replay signal processing circuit 28 at the predetermined timing, a signal is output to the motor driver 27 for controlling the seek motor so that the optical pickup device 23 is positioned at a designated write starting point. It is noted that a 1 ECC-block corresponds to the smallest recording unit, but data may be consecutively recorded in a plurality of ECC blocks in one writing operation if the addresses of the designated area are continuous. However, when a defect area is included in the designated area, the continuity of the addresses of the designated area is disrupted by the defect area. That is, the areas are divided by the defect area into sections, and the writing operation is performed for each of the divided sections.

When the amount of user data accumulated in the buffer RAM 34 exceeds a predetermined amount and this information is provided from the buffer manager 37, an instruction is sent to the encoder 25 to generate a write signal, and when the optical pickup device 23 reaches the write starting point, the encoder 25 is notified. In this way, the user data are written on the optical disk 15 via the encoder 25, the laser control circuit 24, and the optical pickup device 23. The recording process is completed when all of the user data received from the host are written on the optical disk 15.

In the following, a detailed description is given of the data replaying process realized in steps 425 and 453.

First, a control signal for controlling the rotation of the spindle motor 22 is output to the motor driver 27 according to the replay speed, and the reception of the read command is signaled to the replay signal processing circuit 28. In this way, the tracking control and focus control may be performed when the rotation speed of the optical disk 15 reaches a predetermined linear speed. It is noted that the tracking control and focus control may be performed as necessary or desired throughout the replaying process.

Then, referring to the defect information, if the designated read area includes a defect area, a corresponding replacement area is arranged to be the read area. Thus, based on the ADIP information output from the replay signal processing circuit 28 at the predetermined timing, a signal is output to the motor driver 27 for controlling the seek motor so that the optical pickup device 23 is positioned at a read starting point.

When the optical pickup device 23 reaches the read starting point, the replay signal processing circuit 28 is notified. In this way, the replay data may be accumulated in the buffer RAM 34 via the replay signal processing circuit 28 as described, and the replay data may also be handled as sector data to be transmitted to the host via the buffer manager 37 and the interface 38. When all data designated by the host are replayed, the replaying process is completed.

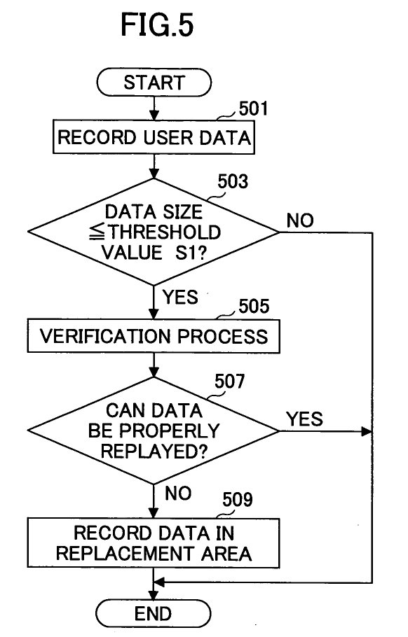

Next, referring to FIG. 5, a recording operations process is described for recording data on the optical disk 15 upon receiving a write command from the host after the formatting process has been completed on the optical disk 15. FIG. 5 is a flowchart illustrating process steps corresponding to a sequence of process algorithms executed by the CPU 40. When a write command is received from the host, a start address of the program corresponding to the flowchart of FIG. 5 is set to a program counter of the CPU 40 and the operations process is started.

First, in step 501, the user data received from the host are recorded in the designated area of the user data area (UDA) as described above. When the recording of the user data is completed, the process moves on to step 503.

In step 503, a determination is made as to whether the data size of the user data is less than or equal to the threshold value S1. If the data size is less than or equal to the threshold value S1, a positive determination is made, in which case the verification process is determined to be executed, and the process moves on to step 505.

In step 505, the verification process is performed.

Then, in step 507, a determination is made as to whether the user data recorded in the designated area can be properly replayed based on the result of the verification process. If the user data cannot be properly replayed, a negative determination is made in this step and the process moves on to step 509.

In step 509, the user data are recorded in a predetermined replacement area, and the defect information is stored in the RAM 41, after which the operations process performed in response to the reception of a write command is ended. The defect information stored in the RAM 41 may, for example, be recorded in the MTA and STA of the optical disk 15 when it is to be discharged.

In step 503, if the data size exceeds the threshold value S1, a negative determination is made, in which case the verification process is determined not to be executed, and the process performed in response to a write command is ended without executing the verification process.

As is appreciated from the above descriptions, in the optical disk apparatus according to the present embodiment, recording means, determination means, and replacement means of the present invention are realized by the CPU 40 and programs executed by the CPU 40. Specifically, the recording means is realized by each of the processes executed in step 415 of FIG. 3, step 441 of FIG. 4, and step 501 of FIG. 5; the determination means is realized by each of the processes executed in step 417 of FIG. 3, step 445 of FIG. 4, and step 503 of FIG. 5; and the replacement means is realized by each of the processes executed in steps 419˜423 of FIG. 3, steps 447˜451 of FIG. 4, and steps 505˜509 of FIG. 5. However, it is noted that the present embodiment is merely an illustrative example, and the present invention is by no way limited to this embodiment. For example, at least one portion of the functions realized by the processes of the CPU 40 according to corresponding programs may be realized by a hardware component, or all the functions may be realized by hardware components.

Also, according to the present embodiment, a recording process program of the present invention is installed in the ROM 39, and is implemented as the programs corresponding to process steps 415˜423 in FIG. 3, the programs corresponding to process steps 441˜451 in FIG. 4, and the programs corresponding to process steps 501˜509 in FIG. 5. Specifically, in FIG. 3, a first procedure is realized by the program corresponding to the process of step 415, a second procedure is realized by the program corresponding to the process of step 417, and a third procedure is realized by the program corresponding to the processes of steps 419˜423. In FIG. 4, the first procedure is realized by the program corresponding to the process of step 441, the second procedure is realized by the program corresponding to the process of step 445, and the third procedure is realized by the program corresponding to the processes of steps 447˜451. In FIG. 5, the first procedure is realized by the program corresponding to the process of step 501, the second procedure is realized by the process of step 503, and the third procedure is realized by the program corresponding to the processes of steps 505˜509.

Further, in FIG. 3, a first step of a recording method according to the present invention is realized by process step 417, a second step is realized by process steps 419 and 421, and a third step is realized by process step 423. In FIG. 4, the first step of the recording method according to the present invention is realized by process step 445, the second step is realized by process steps 447 and 449, and the third step is realized by the process step 451. In FIG. 5, the first step of the recording method according to the present invention is realized by process step 503, the second step is realized by process steps 505 and 507, and the third step is realized by the process step 509.

As is described above, according to the present embodiment, when user data are recorded in an area, if the data size of the user data is less than or equal to the threshold value S1, a verification process on the recorded area is performed even if this area has already undergone the verification process at least once before the recording. Normally, a rewritable optical disk has an area for recording the actual user data (also referred to as ‘file data’ hereinafter) as well as a so-called file system area in which data for managing the recording information of the file data upon recording the file data (referred to as ‘file system data’ hereinafter) are recorded. Thus, even when the file data recorded in the user data area is physically broken up into sections within the user data area, the user data may be replayed in logical continuity using the file system data. The file system data are changed each time an addition, alteration, and deletion, for example, of the file data takes place. Thus, the file system area is rewritten on a more frequent basis compared to the area for recording the file data. Consequently, the file system area is more likely to turn into an acquired defect area. In general, the optical disk apparatus does not make a distinction between file system data and file data upon recording user data, and both types of data that are processed correspond to user data to be recorded in the user data area. Nevertheless, file system data tends to have a relatively small data size whereas the data size of the file data tends to be quite large. Thus, in the present embodiment, by setting the threshold value to a value that is slightly larger than the data size of the file system data, for example, the verification process may be performed when the data being recorded corresponds to file system data, and the verification process may be omitted when the data being recorded corresponds to file data. That is, by performing the verification process on areas that are frequently rewritten, recording may be realized with due consideration for acquired defects of the recording region to thereby enable high quality recording while preventing the degradation of the recording performance.

In the above example, the entire user data can be stored in the buffer RAM 34. However, if the memory capacity of the area provided in the buffer RAM 34 for storing the user data is small and if the size of the data that can be stored in the buffer RAM 34 is smaller than the data size of the user data, data are successively written over previously written data to complete the user data recording. In such case, instead of determining whether a verification process should be performed based on the data size of the user data, the area in which the data remaining in the buffer RAM 34 without being overwritten (a portion of the user data) are recorded may be obtained, and the verification process may be performed on this area.

In the following, processes performed in the optical disk apparatus 20 are described for a case in which the optical disk 15 is not a blank disk and has already been formatted by another optical disk apparatus.

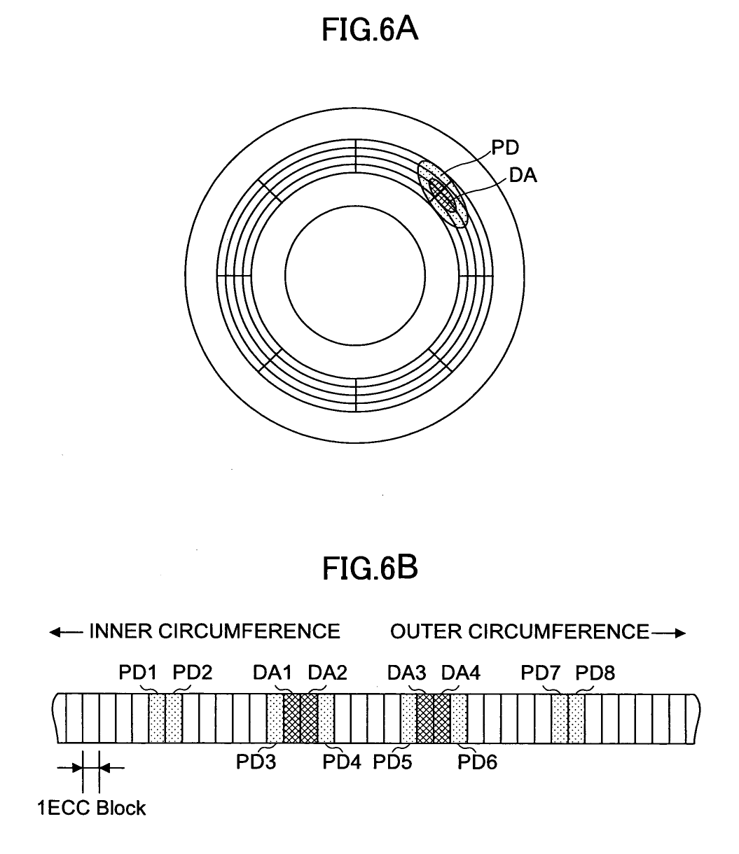

FIG. 6A is a diagram illustrating an exemplary result of a verification process performed on the optical disk 15 by an optical disk apparatus. In this example, a defect area DA is detected. In general, a surrounding area of a defect area DA may also be defective to some extent, this area being referred to as a semi-defect area PD. FIG. 6B illustrates a portion of the recording region of FIG. 6A. In this drawing, ECC blocks DA1˜DA4 each correspond to a block included in the defect area DA, and ECC blocks PD1˜PD8 each correspond to a block included in the semi-defect area PD.

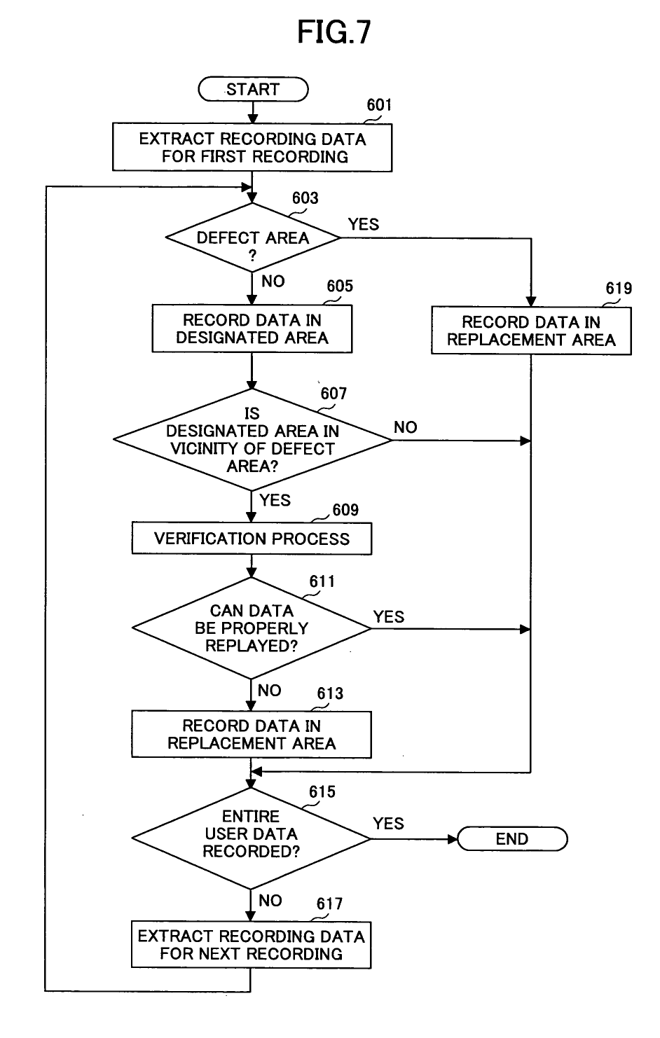

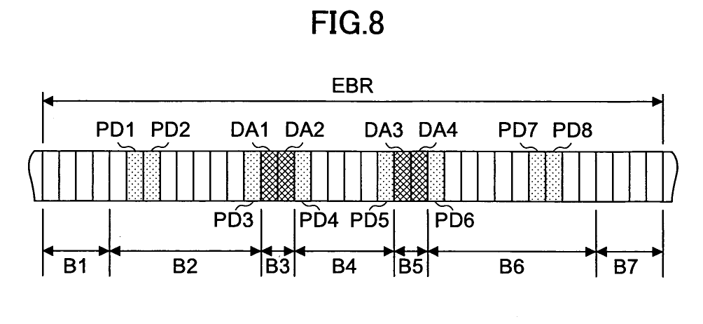

As is described above, in the Mt. Rainier standard, a determination criterion based on which an area is determined to be a defect area in the verification process is not provided, and the determination criterion is individually set by each manufacturer of an optical disk apparatus. Thus, if the determination criterion used by the optical disk apparatus 20 and the determination criterion used by an optical disk apparatus that has executed the verification process on the optical disk 15 as shown in FIG. 6A are different, then data recorded in the semi-defect area may not be properly replayed in the optical disk apparatus 20. Even if the determination criteria of the respective apparatuses are very similar, data may still be recorded under dubious circumstances of not being certain whether data recorded in the semi-defect area can be properly replayed. In the present embodiment, instead of determining whether the verification process should be performed based on the data size of the user data, the determination may be performed based on the physical positioning of the designated area and the known defect area(s), for example. An operations process of the CPU 40 in such case is briefly described below using a flowchart shown in FIG. 7. In this example, it is assumed that area EBR (made up of 37 consecutive ECC blocks) shown in FIG. 8 corresponds to the designated area. Also, it is assumed that the entire user data can be simultaneously stored in the buffer RAM 34.

First, in step 601 of FIG. 7, the user data to be recorded in a first recording are extracted from the buffer RAM 34. In the present example, user data that are to be recorded in areas B1 and B2 are extracted.

Then, in step 603, a determination is made as to whether the designated area in which the extracted user data (also referred to as ‘recording data’ hereinafter) are to be recorded corresponds to a defect area by referring to the defect information. In the present example, since the areas B1 and B2 do not correspond to defect areas, a negative determination is made in step 603 and the process moves on to step 605.

In step 605, the recording data is recorded in the designated area.

Then, in step 607, a determination is made as to whether the designated area in which the recording data has been recorded is in the vicinity of a defect area (e.g., within the range of 10 blocks to and from a defect area) by referring to the defect information. In the present example, the area B2 of FIG. 8 is positioned in the vicinity of a defect area. Accordingly, a positive determination is made in step 607, in which case the verification process is determined to be performed, and the process moves on to step 609.

In step 609, the verification process is performed on the area in the vicinity of the defect area (i.e., area B2 in this example).

Then, in step 611, a determination is made as to whether the recorded data can be properly replayed based on the result of the verification process. If the data can be properly replayed, a positive determination is made in step 611, and the process moves on to step 615. On the other hand, if the data cannot be properly replayed, a negative determination is made in step 611, and the process moves on to step 613.

In step 613, the data that cannot be properly replayed are recorded in a predetermined replacement area, and the defect information is stored in the RAM 41, after which the process moves on to step 615.

In step 615, a determination is made as to whether all the user data have been recorded. In this example, merely 13 blocks out of the 37 designated blocks are recorded, and accordingly, a negative determination is made and the process moves on to step 617.

In step 617, recording data for a next recording are extracted, and the process goes back to step 603.

In step 603, if the designated area in which the recording data are to be recorded corresponds to a defect area such as the areas B3 and B5 of FIG. 8, a positive determination is made, and the process moves on to step 619.

In step 619, the recording data are recorded in a predetermined replacement area and the process moves on to step 615.

Also, in step 607, if the designated area in which the recording data have been recorded does not include an area in the vicinity of a defect area, a negative determination is made, in which case the verification process is determined not to be performed, and the process moves on to step 615.

When all the user data in the RAM 34 have been recorded, a positive determination is made in step 615, and the operations process performed in response to the reception of a write command is ended.

According to this arrangement, the verification process is not performed on areas B1 and B7 of FIG. 8, and the verification process is performed on areas B2, B4, and B6. Since the verification process is performed upon recording data in semi-defect areas, a predetermined recording quality can be maintained. It is noted that in the present example, areas in the vicinity of a defect area are defined as blocks within a range of 10 blocks to and from a defect area; however, the present invention is not limited to this arrangement, and other definitions may be set for the vicinity area. For example, different numbers may be set for the number of blocks to and the number of blocks from the defect area with respect to the range defining the vicinity area. Also, the vicinity area may be defined as predetermined blocks before a defect area or predetermined blocks after a defect area, for example.

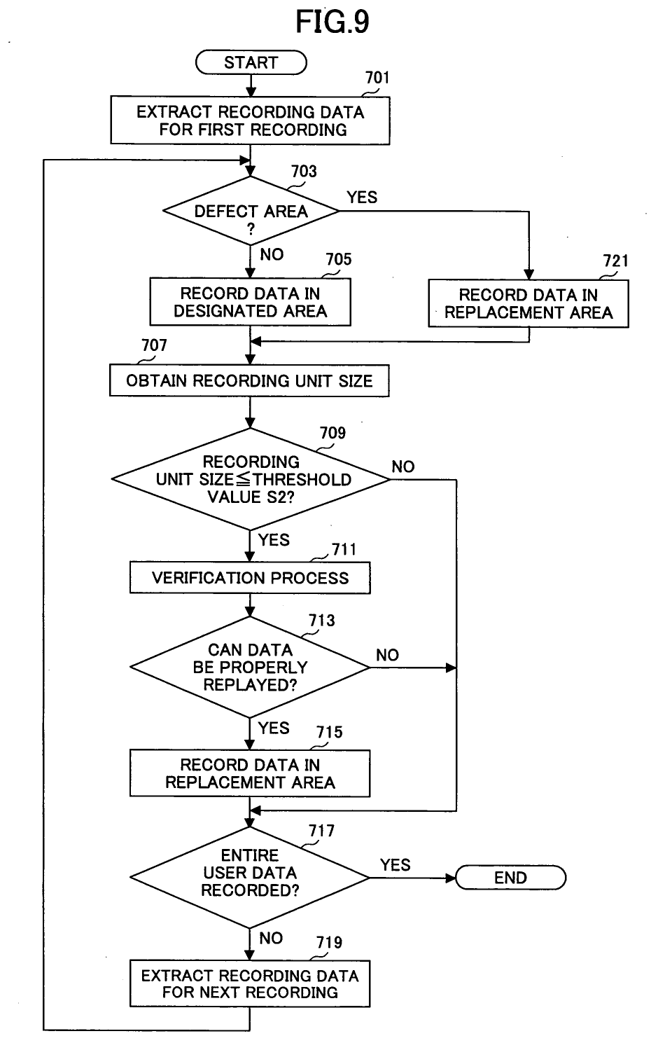

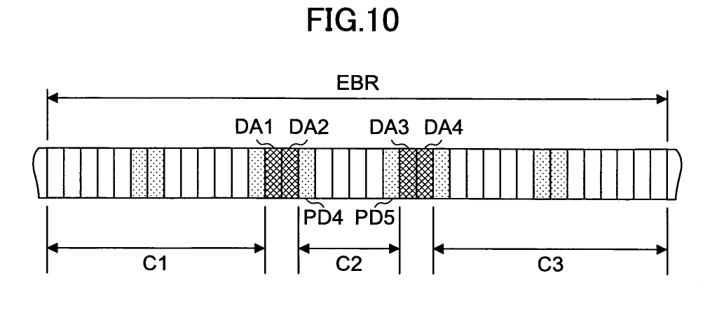

In another example, the determination of whether the verification process should be performed may be made based on the data size of data that is recorded in one writing operation, namely, the recording unit size. FIG. 9 is a flowchart illustrating an operations process of the CPU 40 in this example. In the following description, it is assumed that area EBR shown in FIG. 10 corresponds to the designated area, the replacement area for defect area DA1 and the replacement area for defect area DA2 are consecutive, and the replacement area for defect area DA3 and the replacement area for defect area DA4 are consecutive. Thus, user data received from the host are recorded in 5 recordings. Specifically, the first recording is performed on area C1, the second recording on the replacement areas for defect areas DA1 and DA2, the third recording on area C2, the fourth recording on the replacement areas for defect areas DA3 and DA4, and the fifth recording on area C3. In this case, the recording unit size of the recordings are 13 blocks for the first recording, 2 blocks for the second recording, 6 blocks for the third recording, 2 blocks for the fourth recording, 14 blocks for the fifth recording. Also, it is assumed that all the user data can be stored in the buffer RAM 34 at once.

In this process, first, in step 701 of FIG. 9, data that are to be consecutively recorded in the first recording are extracted from the buffer RAM 34. In the present example, data to be recorded in area C1 shown in FIG. 10 are extracted as recording data (partial data).

Then, in step 703, a determination is made as to whether the designated area in which the recording data are to be recorded corresponds to a defect area. In the present example, since area C1 does not correspond to a defect area, a negative determination is made, and the process moves on to step 705.

In step 705, the recording data are recorded in the designated area. In the present example, recording data are recorded in area C1.

Then, in step 707, the recording unit size is obtained.

Next, in step 709, a determination is made as to whether the recording unit size is less than or equal to a predetermined second threshold value S2 (e.g., 10 (blocks)). In this example, since the recording unit size is 13 blocks for recording data in area C1, a negative determination is made in step 709, in which case the verification process is determined not to be performed, and the process moves on to step 717.

In step 717, a determination is made as to whether the entire user data have been recorded. In the present example, data are only recorded in area C1, and therefore, a negative determination is made in step 717, and the process moves on to step 719.

In step 719, data to be consecutively recorded in a next recording are extracted from the buffer RAM 34 as recording data, and the process goes back to step 703.

In step 709, if the recording unit size is less than or equal to the threshold value S2, a positive determination is made, namely, the verification process is determined to be performed, and the process moves on to step 711.

In step 711, the verification process is performed on the designated area in which the recording data are recorded.

Then, in step 713, a determination is made as to whether the recorded data can be properly replayed based on the result of the verification process. If the data can be properly replayed, a positive determination is made in step 713, and the process moves on to step 717. On the other hand, if the data cannot be properly replayed, a negative determination is made in step 713, and the process moves on to step 715.

In step 715, the recording data that cannot be properly replayed are recorded in a predetermined replacement area and the defect information is stored in the RAM 41, after which the process moves on to step 717.

Also, if the designated area in which the recording data are to be recorded corresponds to a defect area, a positive determination is made in step 703, and the process moves on to step 721.

In step 721, the recording data are recorded in the predetermined replacement area, and the process moves on to step 707.

According to the present example, the verification process is not performed on areas C1 and C3 of FIG. 10, and the verification process is performed on area C2 and the replacement areas. The present example is particularly effective for maintaining a predetermined recording quality while preventing the degradation of the recording performance in a case where many known defect areas exist.

Further, in the flowchart process of FIG. 9, if the memory capacity of an area provided in the buffer RAM 34 for storing user data is small and the size of user data that can be stored in this area of the buffer RAM 34 is smaller than the data size of the user data being sent thereto, the threshold value S2 may be set to a value corresponding to the memory capacity of the area provided in the buffer RAM 34 for storing the user data.

Alternatively, when the size of user data that can be stored in the buffer RAM 34 is smaller than the data size of the user data being sent thereto, the verification process may be performed on verifiable areas.

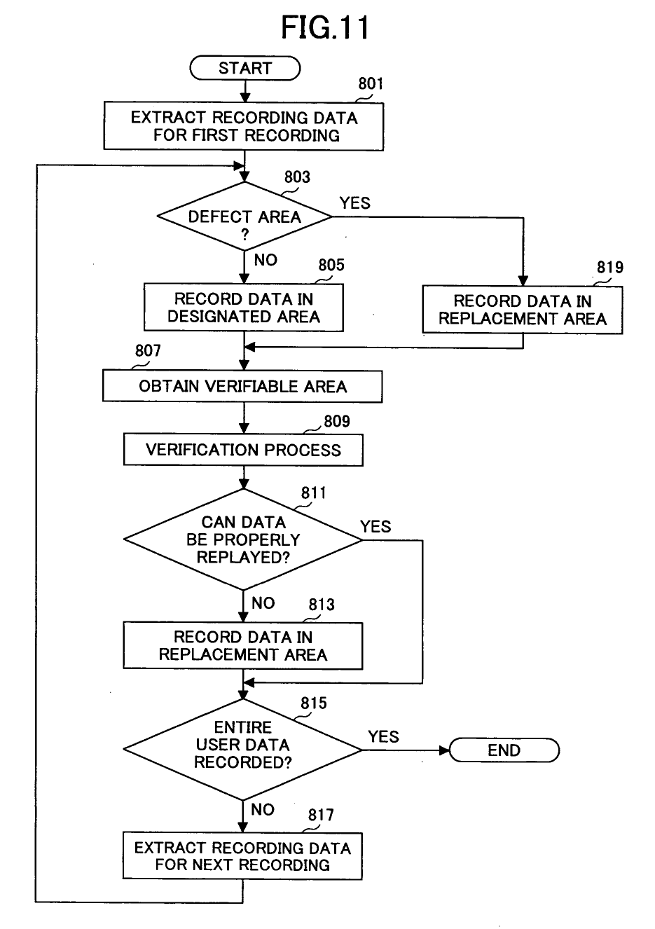

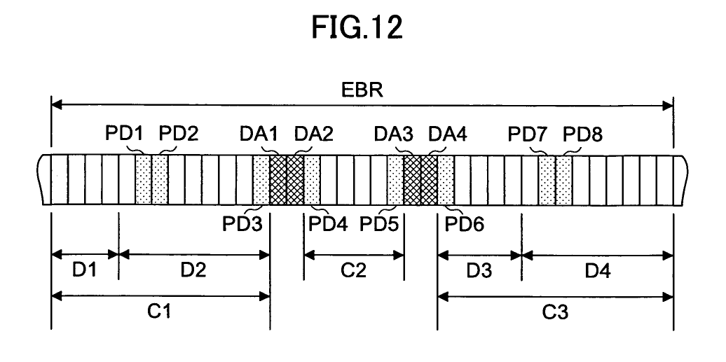

FIG. 11 is a flowchart illustrating an operations process of the CPU 40 in such an arrangement. In the following description, it is assumed that area EBR of FIG. 12 corresponds to the designated area, and the user data received from the host are recorded in five recordings as in the previous example. Also, it is assumed that 9 blocks corresponds to the amount of data (data size) that can be stored in the buffer RAM 34.

First, in step 801, user data that are to be recorded in a first consecutive recording are successively extracted from the buffer RAM 34. In the present example, data to be recorded in area C1 of FIG. 12 are extracted as recording data. Since 9 blocks is the amount of data that can be stored in the buffer RAM 34 according to the present example, data that are to be recorded in area D2 are written over the data that are to be recorded in area D1 in the buffer RAM 34.

Then, in step 803, a determination is made as to whether the designated area in which the recording data are to be recorded corresponds to a defect area. Since area C1 does not correspond to a defect area, a negative determination is made in step 803 according to the present example, and the process moves on to step 805.

In step 805, the recording data are recorded in the designated area, that is, the recording data are recorded in area C1 in the present example.

In step 807, a verifiable area is obtained based on the recording data remaining in the buffer RAM 34. In the present example, area D2 corresponds to the verifiable area.

Next, in step 809, the verification process is peformed on the verifiable area.

Then, in step 811, a determination is made as to whether data recorded in the verifiable area can be properly replayed based on the result of the verification process. If the data can be properly replayed, a positive determination is made in step 811, and the process moves on to step 815. On the other hand, if the data cannot be properly replayed, a negative determination is made in this step, and the process moves on to step 813.

In step 813, the data that cannot be properly replayed are recorded in a predetermined replacement area, and the defect information is stored in the RAM 41, after which the process moves on to step 815.

In step 815, a determination is made as to whether the entire user data have been recorded. In the present example, only the user data for area C1 are recorded, and accordingly, a negative determination is made in step 815, and the process moves on to step 817.

In step 817, data to be recorded in a next consecutive recording are extracted from the buffer RAM 34 as recording data, after which the process goes back to step 803.

In step 803, if the designated area in which the recording data are to be recorded corresponds to a defect area, a positive determination is made, and the process moves on to step 819.

In step 819, the recording data are recorded in a predetermined replacement area, after which the process moves on to step 807.

Thus, in the present example, the verification process is not performed on areas D1 and D3 of FIG. 12, and the verification process is performed on areas D2, C2, D4, and the replacement areas. In this way, a predetermined recording quality may be maintained while preventing the degradation of the recording performance.

According to the present embodiment, the determination of whether an area corresponds to a defect area is made based on an error rate detected upon replaying the data recorded in the area. However, the present invention is not limited to this embodiment and, for example, a signal level of a replay signal may be used as one of the determination criteria.

Also, according to the present embodiment, it is assumed that the optical disk 15 corresponds to an optical disk conforming to the DVD+MRW standard. However, the present invention is not limited to this embodiment and, for example, the present invention may be applicable to a case in which the optical disk conforms to the CD-MRW standard. In other words, the optical disk may be any type of information recording medium conforming to a standard that includes a defect management function.

Also, according to the present embodiment, the optical disk apparatus has one semiconductor laser; however, the present invention is not limited to this embodiment and, for example, a plurality of semiconductor lasers emitting optical beams with different wavelengths may be implemented. In such case, the optical disk apparatus may include at least one of a semiconductor laser that emits an optical beam having a wavelength of 405 nm, a semiconductor laser that emits an optical beam having a wavelength of 660 nm, and a semiconductor laser that emits an optical beam having a wavelength of 780 nm.

Also, according to the present embodiment, the recording process program is stored in the ROM 39; however, the program may be stored in other types of storage media such as a CD-ROM, a magneto-optical disk, a flash memory, and a flexible disk, for example. In such case, a drive apparatus for the storage medium may be additionally implemented, and the recording process program may be installed from the drive apparatus. In other words, the recording process program may be stored anywhere as long as it can be loaded into the main memory of the CPU 40.

The present application is based on and claims the benefit of the earlier filing date of Japanese priority application No.2003-014202 filed on Jan. 23, 2003, the entire contents of which are hereby incorporated by reference.

What is claimed is:

1. A recording method for recording data in a recording area of an information recording medium, comprising:
a first step of determining whether to perform a defect detection process on at least a portion of the recording area in which the data are recorded based on a predetermined determination criterion pertaining to recording attribute information of the data.

2. The recording method as claimed in claim 1, wherein the recording area includes an area on which the defect detection process is already performed at least once.

3. The recording method as claimed in claim 1, wherein:
the recording attribute information includes information on a data size of the data; and
the determination criterion corresponds to a criterion of determining to perform the defect detection process when the data size of the data is less than or equal to a preset first threshold value.

4. The recording method as claimed in claim 1, wherein:
the recording attribute information includes division information pertaining to dividing the data into a plurality of data sections; and
the determination criterion corresponds to a criterion of determining to perform the defect detection process when a data section of which a data size is less than or equal to a preset second threshold value exists among the data sections, the defect detection process being performed on at least a portion of the recording area in which said data section is recorded.

5. The recording method as claimed in claim 1, wherein:
the recording attribute information includes information pertaining to the recording area in which the data are recorded; and
the determination criterion corresponds to a criterion of determining to perform the defect detection process when the recording area includes an area that is in a vicinity of a known defect area.

6. The recording method as claimed in claim 1, further comprising:
a second step of performing the defect detection process when a determination is made in the first step to perform the defect detection process to determine whether a defect area is included in the processing area; and
a third step of recording defect area data in a predetermined replacement area when a defect area is detected in the second step.

7. The recording method as claimed in claim 1, wherein the defect detection process corresponds to a verification process.

8. The recording method as claimed in claim 1, wherein the information recording medium conforms to a Mt. Rainier standard.

9. A program that is implemented in an information recording apparatus that is adapted to record information on an information recording medium, said program being run on a control computer of the information recording apparatus to realize:
a first procedure of recording data in a recording area of the information recording medium in response to a request from an external source; and
a second procedure of determining after the recording of the data whether to perform a defect detection process on at least a portion of the recording area in which the data are recorded based on a predetermined determination criterion pertaining to recording attribute information of the data.

10. The program as claimed in claim 9, further comprising:
a third procedure of performing the defect detection process when a determination is made in the second procedure to perform the defect detection process, and if a defect area is detected, recording defect area data of the defect area in a predetermined replacement area.

11. A computer readable storage medium storing a program that is implemented in an information recording apparatus that is adapted to record information on an information recording medium, said program being run on a control computer of the information recording apparatus to realize:
a first procedure of recording data in a recording area of the information recording medium in response to a request from an external source; and
a second procedure of determining after the recording of the data whether to perform a defect detection process on at least a portion of the recording area in which the data are recorded based on a predetermined determination criterion pertaining to recording attribute information of the data.

12. An information recording apparatus that is adapted to record information on an information recording medium, said apparatus comprising:
recording means for recording data on the information recording medium in response to a recording request from an external apparatus; and
determination means for determining after the recording of the data whether to perform a defect detection process on at least a portion of the recording area in which the data are recorded based on recording attribute information of the data.

13. The information recording apparatus as claimed in claim 12, further comprising:
replacement means for performing the defect detection process when a determination is made by the determination means to perform the defect detection process, and if a defect area is detected, recording defect area data of the defect area in a predetermined replacement area.

14. The information recording apparatus as claimed in claim 12, wherein:
the recording attribute information includes information on a data size of the data; and
the determination means determines to perform the defect detection process when the data size of the data is less than or equal to a preset first threshold value.

15. The information recording apparatus as claimed in claim 14, further comprising:
a memory for temporarily storing the data, wherein
the first threshold value is set to a value corresponding to an amount of data that can be stored in the memory.

16. The information recording apparatus as claimed in claim 12, wherein:
the recording attribute information includes division information pertaining to dividing the data into a plurality of data sections; and
the determination means determines to perform the defect detection process when a data section of which a data size is less than or equal to a preset second threshold value exists among the data sections, the defect detection process being performed on at least a portion of the recording area in which said data section is recorded.

17. The information recording apparatus as claimed in claim 16, further comprising:
a memory for temporarily storing the data, wherein
the second threshold value is set to a value corresponding to an amount of data that can be stored in the memory.

18. The information recording apparatus as claimed in claim 12, wherein:
the recording attribute information includes information pertaining to the recording area in which the data are recorded; and
the determination means determines to perform the defect detection process when the recording area in which the data are recorded includes an area that is in a vicinity of a known defect area.

19. The information recording apparatus as claimed in claim 12, further comprising:
a memory for temporarily storing the data, wherein
the determination means obtains information on a partial recording area in which data remaining in the memory are recorded based on the recording attribute information, and determines to perform the defect detection process on said partial recording area.

20. The information recording apparatus as claimed in claim 12, wherein the defect detection process corresponds to a verification process.

21. The information recording apparatus as claimed in claim 12, wherein the information recording medium conforms to a Mt. Rainier standard.

22. A recording method for recording data in a recording area of an information recording medium, comprising:
performing a first verification process on at least a portion of the recording area;
recording data in said portion of the recording area; and
determining whether to perform a second verification process on said portion of the recording area based on whether a predetermined determination criterion has been met.

23. A recording method for recording data in a recording area of an information recording medium, comprising:
recording the data in at least a portion of the recording area; and
determining whether to perform a verification process on the portion of the recording area based on whether the size of the data is less than or equal to a threshold value.

24. A recording method for recording data in a recording area of an information recording medium, comprising:
recording a portion of the data in a designated area of the recording area; and
determining whether to perform a verification process on the designated area based on whether the designated area is within a predetermined vicinity of a defect area of the recording medium.

25. A recording method for recording data in a recording area of an information recording medium, comprising:
recording a portion of the data in a designated area of the recording area;
determining whether to perform a verification process on the designated area based on whether the corresponding recording unit size of the portion of data is less than or equal to a threshold value.

26. A recording method for recording data in a recording area of an information recording medium, comprising:
successively extracting a plurality of portions of the data from a memory, wherein the size of the portions of data exceeds a memory capacity of the memory, and wherein a last portion of data remains in the memory after such extraction;
recording the portions of data in the recording area;
obtaining a verifiable area in which the last portion of data remaining in the memory is recorded; and
performing a verification process on the verifiable area.
